(19) United States
(12) Patent Application Publication
(10) Pub. No.: US 2024/0289517 A1
(43) Pub. Date: Aug. 29, 2024

(54) METHOD, DEVICE AND COMPUTER-READABLE STORAGE MEDIUM FOR IMPLEMENTING MAGNETIC CONFINEMENT REACTION

(71) Applicant: HEFEI INSTITUTES OF PHYSICAL SCIENCE, CHINESE ACADEMY OF SCIENCES, Hefei (CN)

(72) Inventors: Jinping QIAN, Hefei (CN); Zhengping LUO, Hefei (CN); Jiale CHEN, Hefei (CN); Guoqiang LI, Hefei (CN); Ye TAO, Hefei (CN); Hang LI, Hefei (CN); Kun LU, Hefei (CN)

(21) Appl. No.: 18/649,945

(22) Filed: Apr. 29, 2024

(30) Foreign Application Priority Data
Sep. 28, 2023 (CN) 202311264601.9

(51) Int. Cl. G06F 30/20; G21B 1/05

(52) U.S. Cl. CPC G06F 30/20; G21B 1/057

(57) ABSTRACT

A method for implementing a magnetic confinement reaction is provided. An initial equilibrium configuration is constructed based on zero-dimensional parameters. The initial equilibrium configuration is subjected to iteration with a blanket, a divertor and a magnet to determine an equilibrium configuration of a reference equilibrium. A numerical simulation model of a plasma breakdown phase in a start-up process is established using a rigid conductor, and optimally solved to determine a maximum coil current. A phase after the breakdown is optimized into a quadratic programing problem to establish a performance function, which is solved using a preset constraint to determine a to-be-optimized parameter. The start-up process of the superconducting tokamak is completed according to the equilibrium configuration, the maximum coil current and the to-be-optimized parameter. A device and computer-readable storage medium for implementing magnetic confinement reaction are also provided.

### CROSS-REFERENCE TO RELATED APPLICATIONS

This application claims the benefit of priority from Chinese Patent Application No. 202311264601.9, filed on Sep. 28, 2023. The content of the aforementioned application, including any intervening amendments made thereto, is incorporated herein by reference in its entirety.

### TECHNICAL FIELD

This application relates to analysis and evaluation of nuclear reaction devices, and more particularly to a method, device and computer-readable storage medium for implementing a magnetic confinement reaction.

### BACKGROUND

As a clean and efficient energy generation approach, fusion has broad application prospects in the energy field. Magnetic confinement tokamak is a common fusion reactor design, which employs a magnetic field to confine the plasma, thereby achieving fusion reactions under high-temperature and high-density conditions.

The poloidal field coils (including ohmic field coils and shaping field coils) of conventional tokamak devices are usually wound with copper wires, and are arranged close to the vacuum chamber. In addition, the ohmic field coils and shaping field (including balance field) coils are independent of each other. During the plasma breakdown and start-up phase, it is only necessary to optimize the zero-field distribution for the ohmic field coils and the balanced field requirements for the shaping field coils. In a tokamak device, the discharge solution of the high-confinement plasma mainly includes an ohmic heating discharge method which consumes the volt-seconds provided by the central solenoid and other external coils, and an auxiliary heating discharge method which introduces an external auxiliary heating source. The currently-used auxiliary heating methods mainly include electron cyclotron resonance heating systems, ion cyclotron resonance heating systems, neutral beam injection systems, low hybrid wave heating systems and various impurity injection systems. The auxiliary heating discharge method has higher heating efficiency, and can quickly generate the plasma with high temperature and density. However, in the existing high-performance plasma discharge schemes, due to the limited volt-seconds provided by the central solenoid, the ohmic heating-based discharge method fails to sustain the long-pulse operation, and fails to simultaneously maintain plasma stability and a relatively high fusion gain factor.

### SUMMARY

In order to solve the problems in the prior art, this application provides a method, device and computer-readable storage medium for implementing a magnetic confinement reaction, which can simultaneously reach a high plasma stability and a relatively high fusion gain factor through a designed balance bitmap.

Technical solutions of the present disclosure are described as follows.

In a first aspect, this application provides a method for implementing a magnetic confinement reaction, comprising:
step (1) constructing an initial equilibrium configuration based on zero-dimensional parameters;
step (2) subjecting the initial equilibrium configuration to iteration with a blanket, a divertor and a magnet to determine an equilibrium configuration corresponding to a reference equilibrium;
step (3) establishing a numerical simulation model of a plasma breakdown phase in a start-up process using a rigid conductor, and optimally solving the numerical simulation model to determine a maximum coil current;
step (4) optimizing a phase in the start-up process after the plasma breakdown phase into a quadratic programing problem to establish a performance function, and solving the performance function using a preset constraint to determine a to-be-optimized parameter; and step (5) completing the start-up process of a superconducting tokamak according to the equilibrium configuration, the maximum coil current and the to-be-optimized parameter.

In some embodiments, the zero-dimensional parameters comprise plasma current, major radius, minor radius, elongation ratio, 95-plane elongation ratio, triangularity, 95-plane triangularity, top triangularity, bottom triangularity, volume, inner leg length of the divertor and outer leg length of the divertor.

In some embodiments, the step (3) is performed through steps of:
establishing the numerical simulation model of the plasma breakdown phase using the rigid conductor;
setting a voltage of a poloidal field coil to change piecewise and linearly, and converting the numerical simulation model into an integrated model;
designing a maximum excitation current and an initial zero-field optimization to convert the integrated model into a given performance function; and
solving the given performance function by linear least-square fitting according to given device parameters to obtain an excitation current of the poloidal field coil as the maximum coil current;
wherein a circuit equation of active coils of the numerical simulation model is expressed as:

$${M}_{c c} \frac{{dI}_{c}}{dt} + {R}_{c} {I}_{c} + {M}_{c v} \frac{{dI}_{v}}{dt} = {V}_{c} ,$$

and a circuit equation of passive conductors of the numerical simulation model is expressed as:

$${M}_{v v} \frac{{dI}_{v}}{df} + {R}_{v} {I}_{v} + {M}_{c v} \frac{{dI}_{c}}{df} = 0 ,$$

wherein M_{cc} is a mutual inductance between the active coils, Mᵥᵥ is a mutual inductance between the passive conductors, M_{cv}, is a mutual inductance between the active coils and the passive conductors, R_{c} is a resistance of each of the active coils, Rᵥ is a resistance of each of the passive conductors, I_{c} is a current on each of the active coils, Iᵥ is a current on each of the passive conductors, and V_{c} is a voltage across each of the active coils;
the integrated model is expressed as:

$$M \dot{I} + RI = {V}_{0} + {\dot{V}}_{0} t ;$$

wherein M is a mutual inductance matrix, R is a resistance vector, I is a current vector, V₀ is a voltage vector at time t₀, İ is a conductor current change rate, \dot{V}₀ is a voltage change rate at the time t₀, and \dot{V}₀ is expressed as:

$${\dot{V}}_{0} = \frac{{V}_{1} - {V}_{0}}{{t}_{1} - {t}_{0}} ,$$

wherein V₁ is a voltage vector at time t₁;
the given performance function is expressed as:

$$F ( {I}_{i} ) = \vert \begin{matrix}{ψ}_{0} - {\sum }_{i = 1}^{{n}_{c}} {M}_{ci} {I}_{i} \\ {B}_{z 1} - {\sum }_{i = 1}^{{n}_{c}} {G}_{c 1 i} {I}_{i} \\ {B}_{z 2} - {\sum }_{i = 1}^{{n}_{c}} {G}_{c 2 i} I \\ ⋮ \\ {B}_{z {n}_{pt}} - {\sum }_{i = 1}^{{n}_{c}} {G}_{c {{n}_{p t}}^{i}} {I}_{i}\end{matrix} \vert ;$$

wherein n_{c} is the number of loops of the poloidal field coil, ψ₀ is a magnetic flux at a plasma breakdown center, B_{z1}−B_{zn}_{ₚₜ} are magnetic fields in plasma optimization areas, G_{c1i}−G_{cn}_{ₚₜ}ᵢ are Green's functions of the passive conductors versus plasma optimization areas, nₚₜ is the number of the plasma optimization areas, M_{ci} is a mutual inductance coefficient matrix of the passive conductors versus the plasma optimization areas, Iᵢ is a to-be-determined coil current, and F(Iᵢ) is a to-be-optimized performance function;
the given device parameters comprise coordinates of the plasma breakdown center, a size of a vacuum chamber, a maximum number of volt seconds provided by the poloidal field coil, a current limit of the poloidal field coil, a maximum current change rate and a terminal voltage limit of the poloidal field coil.

In some embodiments, the performance function is expressed as:

$$F ( V ) = \sum {( {\overline{Φ}}_{i} - {Φ}_{i}^{tgt} )}^{2} ;$$

wherein V is a coil voltage ratio, Φᵢ^{tgt} is a target value of plasma parameters, comprising loop voltage, vertical field intensity and current ramp-up rate, Φ̅ᵢ is an optimized calculated value of a corresponding plasma parameter, i is a subscript of a to-be-determined plasma parameter, and F(V) is an optimized performance function; and
the preset constraint comprises preset coil parameters and power supply parameters, and the to-be-optimized parameter comprises zero-field distribution, vertical field distribution, loop voltage value and initial rising waveform of a plasma current.

In some embodiments, the method further comprises: driving a plasma using a radio-frequency current distributed in a radial direction, and enhancing a local reversed magnetic shear structure in a safety factor profile to optimize a local magnetic shear.

In some embodiments, the method further comprises:
simulating a state after plasma breakdown with preset parameters, wherein the preset parameters comprise an initial plasma current, an initial equilibrium point and an initial configuration;
monitoring a magnetic flux change at a preset observation point followed by feeding back to a feedback control system, wherein the magnetic flux change comprises a polar position and a vertical position;
controlling, by the feedback control system, an early shaped discharge mode of the plasma to maintain a configuration equilibrium of the plasma; and
heating the plasma with an auxiliary heating power of 20 MW, wherein the auxiliary heating power consists of 10 MW of ion cyclotron wave heating and 10 MW of neutral beam heating, and additionally introducing 2 MW of low-hybrid wave heating during a ramp-up phase, so as to achieve a mixed operation mode.

In some embodiments, the method further comprises:
simulating a state after plasma breakdown with preset parameters, wherein the preset parameters comprise an initial plasma current, an initial equilibrium point and an initial configuration; and
heating plasma with 15 MW of ion cyclotron wave heating, 10 MW of low hybrid wave heating and 6 MW of neutral beam heating, so as to achieve a steady-state operation mode.

In a second aspect, this application provides a device for implementing a magnetic confinement reaction, comprising an constructing module, an iteration module, a first solving module, a second solving module and a breakdown start-up module; wherein the constructing module is configured to construct an initial equilibrium configuration based on zero-dimensional parameters; the iteration module is configured to determine an equilibrium configuration of a reference equilibrium after iterating with a blanket, a divertor and a magnet; the first solving module is configured to establish a numerical simulation model of a plasma breakdown phase in a start-up process using a rigid conductor, and optimally solve the numerical simulation model to determine a maximum coil current; the second solving module is configured to optimize a phase in the start-up process after the plasma breakdown phase into a quadratic programming problem to establish a performance function, and solve the performance function using a preset constraint to determine a to-be-optimized parameter; and the breakdown start-up module is configured to complete the start-up process of a superconducting tokamak according to the equilibrium configuration, the maximum coil current and the to-be-optimized parameter.

In some embodiments, the zero-dimensional parameters comprise plasma current, major radius, minor radius, elongation ratio, 95-plane elongation ratio, triangularity, 95-plane triangularity, top triangularity, bottom triangularity, volume, inner leg length of the divertor and outer leg length of the divertor.

In some embodiments, the first solving module is configured to establish the numerical simulation model of the plasma breakdown phase using the rigid conductor, set a voltage of a poloidal field coil to change piecewise and linearly, convert the numerical simulation model into an integrated model, design a maximum excitation current and an initial zero-field optimization to convert the integrated model into a given performance function, and solve the given performance function by linear least-square fitting according to given device parameters to obtain an excitation current of the poloidal field coil as the maximum coil current; wherein a circuit equation of active coils of the numerical simulation model is expressed as:

$${M}_{c c} \frac{{dI}_{c}}{df} + {R}_{c} {I}_{c} + {M}_{c v} \frac{{dI}_{v}}{df} = {V}_{c} ;$$

and a circuit equation of passive conductors of the numerical simulation model is expressed as:

$${M}_{v v} \frac{{dI}_{v}}{df} + {R}_{v} {I}_{v} + {M}_{c v} \frac{{dI}_{c}}{df} = 0 ;$$

wherein M_{cc} is a mutual inductance between the active coils, Mᵥᵥ is a mutual inductance between the passive conductors, M_{cv} is a mutual inductance between the active coils and the passive conductors, R_{c} is a resistance of each of the active coils, Rᵥ is a resistance of each of the passive conductors, I_{c} is a current on each of the active coils, Iᵥ is a current on each of the passive conductors, and V_{c} is a voltage across each of the active coils;
the integrated model is expressed as:

$$M \dot{I} + RI = {V}_{0} + {\dot{V}}_{0} t ;$$

wherein M is a mutual inductance matrix, R is a resistance vector, I is a current vector, V₀ is a voltage vector at time t₀, İ is a conductor current change rate, \dot{V}₀ is a voltage change rate at the time t₀, and \dot{V}₀ is expressed as:

$${\dot{V}}_{0} = \frac{{V}_{1} - {V}_{0}}{{t}_{1} - {t}_{0}} ,$$

wherein V₁ is a voltage vector at time t₁;
the given performance function is expressed as:

$$F ( {I}_{i} ) = \vert \begin{matrix}{ψ}_{0} - {\sum }_{i = 1}^{{n}_{c}} {M}_{ci} {I}_{i} \\ {B}_{z 1} - {\sum }_{i = 1}^{{n}_{c}} {G}_{c 1 i} {I}_{i} \\ {B}_{z 2} - {\sum }_{i = 1}^{{n}_{c}} {G}_{c 2 i} I \\ ⋮ \\ {B}_{z {n}_{pt}} - {\sum }_{i = 1}^{{n}_{c}} {G}_{c {{n}_{p t}}^{i}} {I}_{i}\end{matrix} \vert ;$$

wherein n_{c} is the number of loops of the poloidal field coil, ψ₀ is a magnetic flux at a plasma breakdown center, B_{z1}−B_{zn}_{ₚₜ} are magnetic fields in plasma optimization areas, G_{c1i}−G_{cn}_{ₚₜ}ᵢ are Green's functions of the passive conductors versus plasma optimization areas, nₚₜ is the number of the plasma optimization areas, M_{ci} is a mutual inductance coefficient matrix of the passive conductors versus the plasma optimization areas, Iᵢ is a to-be-determined coil current, and F(Iᵢ) is a to-be-optimized performance function;
the given device parameters comprise coordinates of the plasma breakdown center, a size of a vacuum chamber, a maximum number of volt seconds provided by the poloidal field coil, a current limit of the poloidal field coil, a maximum current change rate and a terminal voltage limit of the poloidal field coil.

In some embodiments, the performance function is expressed as:

$$F ( V ) = \sum {( {\overline{Φ}}_{i} - {Φ}_{i}^{tgt} )}^{2} ;$$

wherein V is a coil voltage ratio, Φᵢ^{tgt} is a target value of plasma parameters, comprising loop voltage, vertical field intensity and current ramp-up rate, Φ̅ᵢ is an optimized calculated value of a corresponding plasma parameter, i is a subscript of a to-be-determined plasma parameter, and F(V) is an optimized performance function; and
the preset constraint comprises preset coil parameters and power supply parameters, and the to-be-optimized parameter comprises zero-field distribution, vertical field distribution, loop voltage value and initial rising waveform of a plasma current.

In some embodiments, the device further comprises a magnetic shearing module; wherein the magnetic shearing module is configured to drive a plasma using a radio-frequency current distributed in a radial direction, and enhance a local reversed magnetic shear structure in a safety factor profile to optimize a local magnetic shear.

In some embodiments, the device further comprises a mixed operation module; wherein the mixed operation module is configured to simulate a state after plasma breakdown with preset parameters, wherein the preset parameters comprise an initial plasma current, an initial equilibrium point and an initial configuration, monitor a magnetic flux change at a preset observation point followed by feeding back to a feedback control system, wherein the magnetic flux change comprises a polar position and a vertical position, control an early shaped discharge mode of the plasma by the feedback control system to maintain a configuration equilibrium of the plasma, and heat the plasma with an auxiliary heating power of 20 MW, wherein the auxiliary heating power consists of 10 MW of ion cyclotron wave heating and 10 MW of neutral beam heating, and additionally introduce 2 MW of low-hybrid wave heating during a ramp-up phase, so as to achieve a mixed operation mode.

In some embodiments, the device further comprises a steady-state operation module; wherein the steady-state operation module is configured to simulate a state after plasma breakdown with preset parameters, wherein the preset parameters comprise an initial plasma current, an initial equilibrium point and an initial configuration; and heat the plasma with 15 MW of ion cyclotron wave heating, 10 MW of low hybrid wave heating and 6 MW of neutral beam heating, so as to achieve a steady-state operation mode.

In a third aspect, this application provides a terminal equipment, comprising a processor, a memory and a computer program; wherein the computer program is stored in the memory, and configured to be executed by the processor; and the processor is configured to execute the computer program to implement the above method.

In a fourth aspect, this application provides a computer-readable storage medium, wherein a computer program is stored on the computer-readable storage medium; and the computer program is configured to be executed to control a device equipped with the computer-readable storage medium to implement the above method.

This disclosure has the following beneficial effects.

Regarding the method provided herein, the initial equilibrium configuration is constructed based on the zero-dimensional parameters, and is subjected to iteration with the blanket, the divertor and the magnet to determine the equilibrium configuration of the reference equilibrium. The numerical simulation model of the plasma breakdown phase in the start-up process is established using a rigid conductor, and optimally solved to determine the maximum coil current. The phase after the plasma breakdown is optimized into the quadratic programing problem to establish the performance function, which is solved using the preset constraints to determine the to-be-optimized parameters. The plasma breakdown and start-up of the superconducting tokamak is completed according to the equilibrium configuration, the maximum coil current and the to-be-optimized parameters. This application can simultaneously achieve a high plasma stability and a relatively high fusion gain factor.

### BRIEF DESCRIPTION OF THE DRAWINGS

FIG. 1 is a flow chart of a method for implementing a magnetic confinement reaction in accordance with an embodiment of the present disclosure;

FIG. 2 is a polar sectional view of a device for implementing a magnetic confinement reaction in accordance with an embodiment of the present disclosure;

FIG. 3 is a schematic diagram of an external resistor-assisted breakdown circuit in accordance with an embodiment of the present disclosure;

FIG. 4 shows current profile distribution in accordance with an embodiment of the present disclosure;

FIG. 5 is a schematic diagram of a reversed shear structure in accordance with an embodiment of the present disclosure;

FIG. 6 shows temperature and density distribution in accordance with an embodiment of the present disclosure;

FIG. 7 is a structural diagram of the device for implementing the magnetic confinement reaction in accordance with an embodiment of the present disclosure; and

FIG. 8 is a structural diagram of a terminal equipment in accordance with an embodiment of the present disclosure.

### DETAILED DESCRIPTION OF EMBODIMENTS

The technical solutions in the embodiments of the present disclosure will be clearly and completely described below with reference to the accompanying drawings of the present disclosure. Obviously, the described embodiments are some embodiments of the present disclosure, rather than all embodiments. Based on the embodiments described herein, all other embodiments obtained by those skilled in the art without making creative efforts shall fall within the scope of the present disclosure.

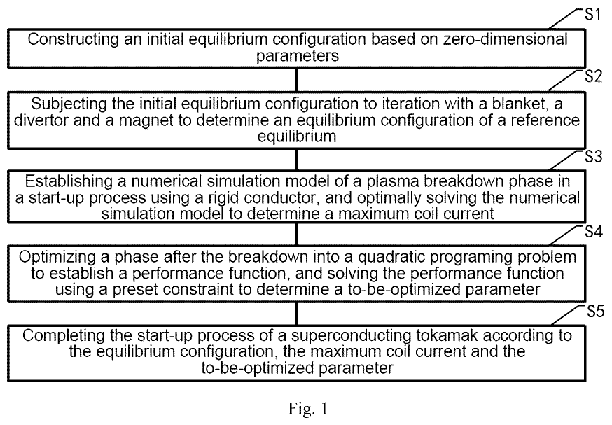

FIG. 1 is a flow chart of a method for implementing a magnetic confinement reaction provided in an embodiment of the present disclosure. The method includes steps (S1)-(S5).
(S1) An initial equilibrium configuration is constructed based on zero-dimensional parameters.
(S2) The initial equilibrium configuration is subjected to iteration with a blanket, a divertor and a magnet to determine an equilibrium configuration corresponding to a reference equilibrium.
(S3) A numerical simulation model of a plasma breakdown phase in a start-up process is established using a rigid conductor. The numerical simulation model is optimally solved to determine a maximum coil current.
(S4) A phase in the start-up process after the plasma breakdown phase is optimized into a quadratic programing problem to establish a performance function. The performance function is solved using a preset constraint to determine a to-be-optimized parameter.
(S5) The start-up process of a superconducting tokamak is completed according to the equilibrium configuration, the maximum coil current and the to-be-optimized parameter.

When implementing this embodiment, the equilibrium configuration of the plasma is a basis for analyzing physics issues of the plasma and designing a tokamak fusion reactor. Both physical parameters and physical objectives of a device need to be checked by constructing an equilibrium. The shape of a first wall of the device needs to be set with reference to a boundary of the equilibrium configuration. A poloidal field coil also needs to be improved by balancing a calculated coil current. The equilibrium configuration also provides a physical basis for the design of the divertor and the placement of a target plate of the divertor.

The initial equilibrium configuration is first constructed based on the zero-dimensional parameters. After the initial equilibrium configuration is iterated with the blanket, the divertor and the magnet, the reference equilibrium is finally obtained.

The numerical simulation model of the plasma breakdown phase in the start-up process is commonly modeled using the rigid conductor. During the plasma breakdown and start-up phase, it is necessary to optimize the zero-field distribution for ohmic field coils and balanced field requirements for shaping field coils. To some extent, coils are hardware decoupled from each other. Conventional conductors allow a coil current to change rapidly, thereby inducing a large breakdown electric field within the vacuum chamber.

The numerical simulation model is optimally solved to determine the maximum coil current.

The phase in the start-up process after the plasma breakdown phase is optimized into the quadratic programing problem to establish the performance function. The performance function is solved using the preset constraint to determine the to-be-optimized parameter.

Based on limit values of parameters of integrated designed superconducting poloidal field coils and power supply, a design of an optimization scheme of the start-up process of the superconducting tokamak is completed. A compact equilibrium configuration which can simultaneously reach a high plasma stability and a relatively high fusion gain factor is designed. The equilibrium configuration satisfies physical and engineering constraints of the first wall, the divertor and the poloidal field coil.

In an embodiment of the present disclosure, the zero-dimensional parameters include plasma current, major radius, minor radius, elongation ratio, 95-plane elongation ratio, triangularity, 95-plane triangularity, top triangularity, bottom triangularity, volume, inner leg length of the divertor and outer leg length of the divertor.

When implementing this embodiment, referring to Table 1, the zero-dimensional parameters for constructing the initial equilibrium configuration mainly include plasma current, major radius, minor radius, elongation ratio, 95-plane elongation ratio, triangularity, 95-plane triangularity, top triangularity, bottom triangularity, volume, inner leg length of the divertor and outer leg length of the divertor.

TABLE 1
Zero-dimensional parameters

| Parameters | Value |
|---|---|
| Plasma current (MA) | 7.37 |
| Major radius (m) | 3.65 |
| Minor radius (m) | 1.10 |
| Elongation ratio | 1.88 |
| 95-plane elongation ratio | 1.81 |
| Triangularity | 0.51 |
| 95-plane triangularity | 0.43 |
| Top triangularity | 0.44 |
| Bottom triangularity | 0.59 |
| Volume (m³) | 147.61 |
| Radial distance between a top divertor | 2.04 |
| separatrix and a lower divertor separatrix | |
| (dRsep) (cm) | |
| Inner leg length of the divertor (cm) | 62.17 |
| Outer leg length of the divertor (cm) | 56.24 |

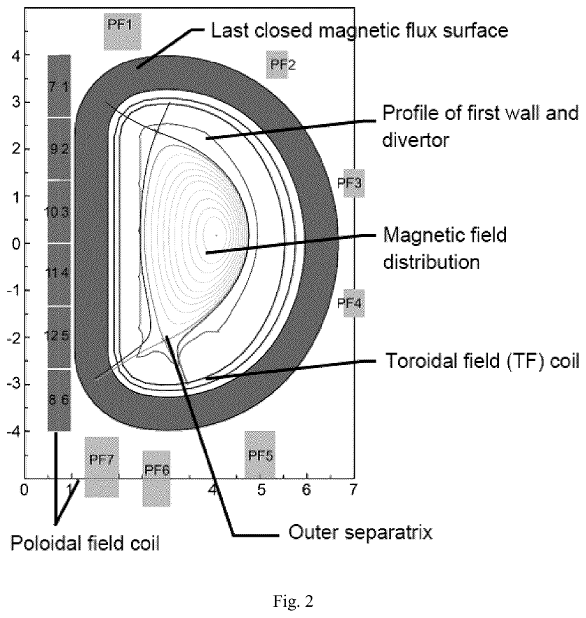

Referring to FIG. 2, which is a polar sectional view of a device for implementing a magnetic confinement reaction provided in an embodiment of the present disclosure, most of plasma in a closed magnetic flux surface is enclosed in a last closed magnetic flux surface.

Positions, number of turns (TURN) and current limits (Iₗᵢₘᵢₜ) of poloidal field coils are shown in Table 2.

TABLE 2
Position, number of turns (TURN) and current
limits (Iₗᵢₘᵢₜ) of the poloidal field coils

| | Rc | Zc | DR | DZ | | Iₗᵢₘᵢₜ |
|---|---|---|---|---|---|---|
| Coils | (mm) | (mm) | (mm) | (mm) | TURN | (kA) |
| CS1 | 0.855 | 3.3475 | 0.25 | 1.308 | 300 | 46 |
| CS2 | 0.855 | 2.00075 | 0.25 | 1.308 | 300 | 46 |
| CS3 | 0.855 | 0.6695 | 0.25 | 1.308 | 300 | 46 |
| CS4 | 0.855 | −0.6695 | 0.25 | 1.308 | 300 | 46 |
| CS5 | 0.855 | −2.00075 | 0.25 | 1.308 | 300 | 46 |
| CS6 | 0.855 | −3.3475 | 0.25 | 1.308 | 300 | 46 |
| CS7 | 0.606 | 3.3415 | 0.2366 | 1.3056 | 160 | 46 |
| CS8 | 0.606 | −3.3415 | 0.2366 | 1.3056 | 160 | 46 |
| CS9 | 0.606 | 2.0049 | 0.2366 | 1.3056 | 160 | 46 |
| CS10 | 0.606 | 0.6683 | 0.2366 | 1.3056 | 160 | 46 |
| CS11 | 0.606 | −0.6683 | 0.2366 | 1.3056 | 160 | 46 |
| CS12 | 0.606 | −2.0049 | 0.2366 | 1.3056 | 160 | 46 |
| PF1 | 2.08 | 4.50 | 0.79 | 0.79 | 256 | 55 |
| PF2 | 2.08 | 4.50 | 0.79 | 0.79 | 108 | 50 |
| PF3 | 2.08 | 4.50 | 0.79 | 0.79 | 96 | 50 |
| PF4 | 2.08 | 4.50 | 0.79 | 0.79 | 96 | 50 |
| PF5 | 2.08 | 4.50 | 0.79 | 0.79 | 260 | 45 |
| PF6 | 2.08 | 4.50 | 0.79 | 0.79 | 288 | 55 |
| PF7 | 2.08 | 4.50 | 0.79 | 0.79 | 312 | 50 |

An appropriate gap is maintained between the last closed magnetic flux surface and the first wall to meet the requirements of heat load distribution on the first wall. A distance from an intersection point of the last closed magnetic flux surface to the divertor, which is a length of legs of the divertor, is also optimized.

The poloidal field coil is a main force in maintaining a shape of the equilibrium configuration. A cross-section of the poloidal field coil, i.e., a current which can be carried by the poloidal field coil, and a distance between the poloidal field coil and the plasma both play a decisive role in a plasma shape and the plasma current. After multiple rounds of iterative optimization, by virtue of a position and a size of the poloidal field coil, a plasma current of 7.37 MA can be maintained while a huge electromagnetic force can be withstood. Specific positions of the poloidal field coil are shown in Table 2.

Furthermore, within a capacity range of the poloidal field coil, a triangularity of 0.51 can be achieved, which facilitates the maintenance of stability of a magnetic fluid. A surrounding magnetic field distribution forms the equilibrium configuration together with an outer separatrix.

The equilibrium configuration satisfies the physical and engineering constraints of the first wall, the divertor and the poloidal field coil.

In an embodiment of the disclosure, the step (S3) is performed through the following steps.

The numerical simulation model of the plasma breakdown phase is established using the rigid conductor.

A voltage of the poloidal field coil is adapted to change piecewise and linearly. The numerical simulation model is converted into an integrated model.

A maximum excitation current and an initial zero-field optimization are designed. The integrated model is converted into a given performance function.

The given performance function is solved using linear least-square fitting according to given device parameters to obtain an excitation current of the poloidal field coil as the maximum coil current.

A circuit equation of active coils of the numerical simulation model is expressed as Equation (1):

$${M}_{c c} \frac{{dI}_{c}}{df} + {R}_{c} {I}_{c} + {M}_{c v} \frac{{dI}_{v}}{df} = {V}_{c} . \qquad ( 1 )$$

A circuit equation of passive conductors of the numerical simulation model is expressed as Equation (2):

$${M}_{v v} \frac{{dI}_{v}}{df} + {R}_{v} {I}_{v} + {M}_{c v} \frac{{dI}_{c}}{df} = 0. \qquad ( 2 )$$

In the equations (1) and (2), M_{cc} is a mutual inductance between the active coils, Mᵥᵥ is a mutual inductance between the passive conductors, M_{cv} is a mutual inductance between the active coils and the passive conductors, R_{c} is a resistance of each of the active coils, Rᵥ is a resistance of each of the passive conductors, I_{c} is a current on each of the active coils, Iᵥ is a current on each of the passive conductors, and V_{c} is a voltage across each of the active coils.

The integrated model is expressed as Equation (3):

$$M \dot{I} + RI = {V}_{0} + {\dot{V}}_{0} t . \qquad ( 3 )$$

In Equation (3), M is a mutual inductance matrix, R is a resistance vector, I is a current vector, V₀ is a voltage vector at time t₀, İ is a conductor current change rate, \dot{V}₀ is a voltage change rate at the time t₀, and \dot{V}₀ is expressed as:

$${\dot{V}}_{0} = \frac{{V}_{1} - {V}_{0}}{{t}_{1} - {t}_{0}} ,$$

where V₁ is a voltage vector at time t₁.

The given performance function is expressed as Equation (4):

$$F ( {I}_{i} ) = \vert \begin{matrix}{ψ}_{0} - {{\sum }^{{n}_{c}}}_{i = 1} {M}_{ci} {I}_{i} \\ {B}_{z 1} - {{\sum }^{{n}_{c}}}_{i = 1} {G}_{c 1 i} {I}_{i} \\ {B}_{z 2} - {{\sum }^{{n}_{c}}}_{i = 1} {G}_{c 2 i} {I}_{i} \\ ⋮ \\ {B}_{{zn}_{pt}} - {{\sum }^{{n}_{c}}}_{i = 1} {G}_{{cn}_{pt} i} {I}_{i}\end{matrix} \vert . \qquad ( 4 )$$

In the equation (4), n_{c} is the number of loops of the poloidal field coil, ψ₀ is a magnetic flux at a plasma breakdown center, B_{z1}−B_{zn}_{ₚₜ} are magnetic fields in plasma optimization areas, G_{c1i}−G_{cn}_{ₚₜ}ᵢ are Green's functions of the passive conductors versus plasma optimization areas, nₚₜ is the number of the plasma optimization areas, M_{ci} is a mutual inductance coefficient matrix of the passive conductors versus the plasma optimization areas, Iᵢ is a to-be-determined coil current, and F(Iᵢ) is a to-be-optimized performance function.

The given device parameters include coordinates of the plasma breakdown center, a size of a vacuum chamber, a maximum number of volt seconds provided by the poloidal field coil, a current limit of the poloidal field coil, a maximum current change rate and a terminal voltage limit of the poloidal field coil.

When implementing this embodiment, the numerical simulation model of the plasma breakdown phase is usually modeled using the rigid conductor. Before breakdown, since the plasma has not yet been generated, the numerical simulation model only needs to consider current changes caused by an active conductor, i.e., the poloidal field coil, driven by a power supply, current changes caused by the passive conductors (such as the vacuum chamber) induced by the active conductor, and a loop voltage generated by the active conductor and the passive conductors in the plasma regions.

The numerical simulation model of the plasma breakdown phase is established using the rigid conductor to obtain the circuit equation of the active coils expressed as Equation (1) and the circuit equation of the passive conductors expressed as Equation (2).

In Equations (1) and (2), M_{cc} is the mutual inductance between the active coils, Mᵥᵥ is the mutual inductance between the passive conductors, M_{cv} is the mutual inductance between the active coils and the passive conductors, R_{c} is the resistance of each of the active coils, Rᵥ is the resistance of each of the passive conductors, I_{c} is the current on each of the active coils, Iᵥ is the current on each of the passive conductors, and V_{c} is the voltage across each of the active coils.

The voltage of the poloidal field coil is set to change piecewise and linearly. The numerical simulation model is converted into the integrated model expressed as Equation (3), where M is the mutual inductance matrix, R is the resistance vector, I is the current vector, V₀ is the voltage vector at the time t₀, İ is the conductor current change rate, \dot{V}₀ is the voltage change rate at the time t₀, and \dot{V}₀ is expressed as:

$${\dot{V}}_{0} = \frac{{V}_{1} - {V}_{0}}{{t}_{1} - {t}_{0}} ,$$

where V₁ is a voltage vector at the time t₁.

It is assumed that

$${\dot{V}}_{0} = \frac{{V}_{1} - {V}_{0}}{{t}_{1} - {t}_{0}}$$

is a constant within a range of t₀≤t≤t₁, then Equation (3) is a system of first-order linear nonhomogeneous differential equations.

It can be seen from Equation (3) that the total number of equations in the system is the number of independently powered poloidal field coil loops of n_{c} plus the number of passive conductor loops of nᵥ. However, to-be-solved variables are (n_{c}+nᵥ) loop currents together with n_{c} coil terminal voltages. Since the number of to-be-solved unknown quantities is less than the number of known equations, Equation (3) is an underdetermined equation. When designing a scheme of the breakdown phase in the start-up process is an optimization problem.

In order to achieve breakdown with a lowest possible coil terminal voltage, a current drop rate of the poloidal field coil needs to be proportioned to achieve a longest possible connection length and a highest possible loop voltage. In order to perform breakdown start-up optimization, the maximum excitation current and the initial zero-field optimization are designed. The integrated model is converted into the given performance function expressed as Equation (4).

Given constraints are solved, such as an optimization problem when Iₘᵢₙ≤I_{c}≤Iₘₐₓ and a maximum magnetic flux in a center of a given device is ψ₀, i.e.,

$${min}_{{I}_{c}} ( F )$$

is solved to obtain a corresponding current ratio Iᵢ_{_{c}} to minimize F(Iᵢ).

In Equation (4), n_{c} is the number of loops of the poloidal field coil, ψ₀ is the magnetic flux at the plasma breakdown center, B_{z1}−B_{zn}_{ₚₜ} are the magnetic fields in the plasma optimization areas, G_{c1i}−G_{cn}_{ₚₜ}ᵢ are Green's functions of the passive conductors versus the plasma optimization areas, nₚₜ is the number of the plasma optimization areas, M_{ci} is the mutual inductance coefficient matrix of the passive conductors versus the plasma optimization areas, Iᵢ is the to-be-determined coil current, and F(Iᵢ) is the to-be-optimized performance function.

According to the given device parameters, such as the coordinates of the plasma breakdown center, the size of the vacuum chamber, the maximum number of volt seconds provided by the poloidal field coil, the current limit of the poloidal field coil, the maximum current change rate and the terminal voltage limit of the poloidal field coil provided by the power supply. The excitation current of the poloidal field coil can be obtained by solving the given performance function by linear least-square fitting, which is the maximum coil current that each poloidal field coil needs to reach at a zero moment of tokamak plasma discharge. At this moment, a sufficiently large zero-field distribution area is established near a desired plasma breakdown point inside the vacuum chamber, which satisfies conditions for the zero-field distribution required for the plasma breakdown phase in the start-up process.

In an embodiment of the disclosure, the performance function is expressed as equation (5):

$$F ( V ) = \sum {( {\overline{Φ}}_{i} - {Φ}_{i}^{tgt} )}^{2} . \qquad ( 5 )$$

In the equation (5), V is a coil voltage ratio, Φᵢ^{tgt} is a target value of plasma parameters including loop voltage, vertical field intensity, and current ramp-up rate, Φ̅ᵢ is an optimized calculated value of a corresponding plasma parameter, i is a subscript of a to-be-determined plasma parameter, and F(V) is an optimized performance function.

The preset constraint includes preset coil parameters and power supply parameters. The to-be-optimized parameter includes zero-field distribution, vertical field distribution, loop voltage value and initial rising waveform of a plasma current.

When implementing this embodiment, after the current ratio is obtained, a loop voltage V₀ in the plasma region is expressed as V₀=2πR₀E₀, where

$${E}_{0} = - \frac{1}{2 π {R}_{0}} \frac{d {ϕ}_{pf}}{dt} ,$$

R₀ is a major radius of a plasma center, E₀ is a strength of a toroidal electric field, and ϕ_{pf} is a magnetic flux of the poloidal field coil.

After generating the plasma through breakdown, the poloidal field coil not only provides the ring voltage for the plasma current to ramp up, but also needs to provide a corresponding vertical field to keep the plasma in a designated area. The current ramp-up rate İₚ of the plasma is commonly estimated using Ejima coefficient C_{Ejima}, expressed as:

$${\dot{I}}_{p} = \frac{( {V}_{0} - {V}_{res} )}{{μ}_{0} {R}_{0} {\hat{L}}_{p}}$$

$$( {V}_{0} - {V}_{res} ) = {V}_{0} ( 1 - {C}_{res} )$$

$${C}_{res} = \frac{{C}_{Ejima}}{{\hat{L}}_{p} + {C}_{Ejima}}$$

$${\hat{L}}_{p} = [ ln ( \frac{8 {R}_{0}}{a \sqrt{κ}} ) + \frac{{ι}_{i}}{2} - 2 ] .$$

Vᵣₑₛ is a resistance ring voltage, μ₀ is a vacuum permeability, Cᵣₑₛ is a resistance loss coefficient as a function of C_{Ejima}, \hat{L}ₚ is a plasma self-inductance of a non-circular cross-section expressed approximately in terms of an equivalent circle radius, a is a minor radius of the plasma, κ is the elongation ratio, and tᵢ is a self-inductance in the plasma per unit length.

The vertical field intensity B_{z} required to keep the plasma at a specified position is expressed as Equation (6):

$${B}_{z} = - \frac{{μ}_{0} {I}_{p}}{4 π {R}_{0}} [ {\hat{L}}_{p} + β + \frac{1}{2} ] . \qquad ( 6 )$$

In the equation (6), Iₚ is the plasma current, and β is a plasma specific pressure which is a ratio of a volume average pressure of the plasma a toroidal magnetic field pressure.

The phase in the start-up process after the plasma breakdown phase is optimized into the quadratic programing problem. The performance function F(V) is solved to obtain the coil voltage ratio V to minimize F(V).

The performance function is expressed as Equation (5), where Φᵢ^{tgt} is the target value of the plasma parameters including loop voltage, vertical field intensity, and current ramp-up rate, Φ̅ᵢ is the optimized calculated value of the corresponding plasma parameter, i is the subscript of the to-be-determined plasma parameter, and F(V) is the optimized performance function.

After the excitation current is solved and determined, an optimal design of the plasma breakdown phase in the start-up process is started, which is to solve

$${min}_{{V}_{c}} ( F )$$

based on given constraints, such as Vₘᵢₙ≤V_{c}≤Vₘₐₓ.

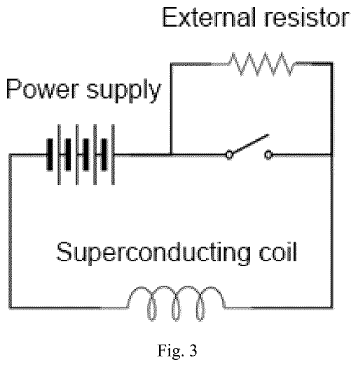

An appropriate breakdown loop voltage is selected based on parameters of the passive conductors (such as the vacuum chamber) and the poloidal field coil, such as mounting position, size, number of turns and current limit. A superconducting coil is arranged far away from the vacuum chamber, and has large size and a large number of turns. A current change rate of the superconducting coil should not be too large. In addition, coil power supply has limited power, thereby failing to provide sufficient voltage during the start-up process. Therefore, an external resistor is usually required to assist in plasma breakdown. FIG. 3 is a schematic diagram of an external resistor-assisted breakdown circuit provided in an embodiment of the disclosure. At this time, it is equivalent to replace a resistance of the superconducting coil itself with a resistance of the external resistor in Equation (1). With respect to the superconducting coil, R_{c} is an extremely small value, thereby reducing the need for power supply voltage.

According to given parameters of the coil and power supply, quadratic programming can be used to solve the performance function, thereby obtaining the coil current and voltage values at each optimization target moment of the breakdown phase in the start-up process, thus obtaining the to-be-optimized parameter, such as zero-field distribution, vertical field distribution, loop voltage value and initial rising waveform of the plasma current.

Based on limit values of parameters of an integrated designed superconducting poloidal field coil and power supply, the design of the optimization scheme of the plasma breakdown and start-up of the superconducting tokamak is completed.

In an embodiment of the disclosure, the method further includes the following steps.

A plasma is driven using a radio-frequency current distributed in a radial direction. A local reversed magnetic shear structure in a safety factor profile is enhanced to optimize a local magnetic shear.

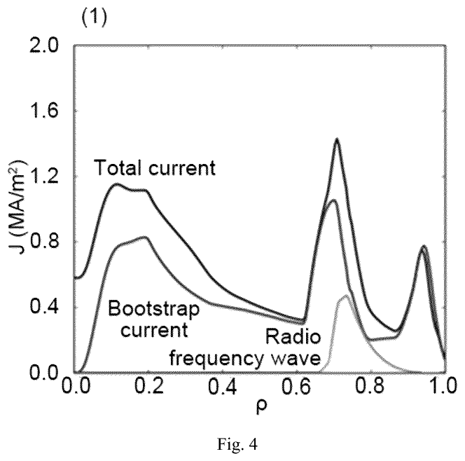

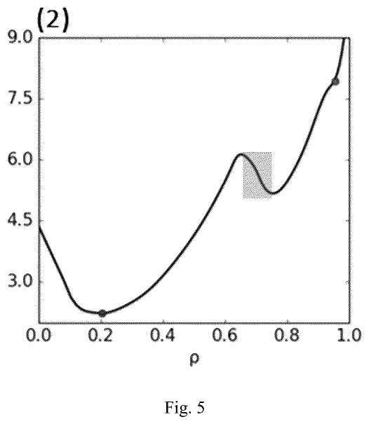

When implementing this embodiment, after completing the design of the optimization scheme of the plasma breakdown and start-up of the superconducting tokamak, current distribution, an anti-shear structure and temperature and density distribution are obtained, referring to FIG. 4, which shows current profile distribution provided in the embodiment of the disclosure. FIG. 4 schematically illustrates current profiles of a total current, a bootstrap current and a radio frequency wave. The radio-frequency current is used to drive the current profile distribution as shown in FIG. 3, thereby enhancing the local reversed shear structure in the safety factor profile. FIG. 5 schematically shows a reversed shear structure provided in an embodiment of the present disclosure. Referring to the shaded area in FIG. 5, an effect of reversed shear on suppressing turbulent transport is enhanced. Such effect can contribute to the formation of core energy and particle transport barriers, thereby reducing the difficulty of obtaining “an internal transport barrier” in temperature and density profiles of the plasma.

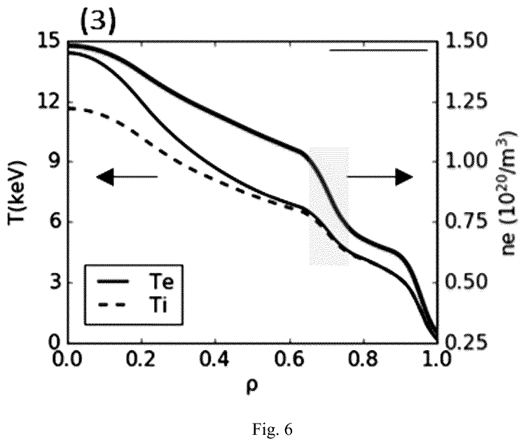

FIG. 6 is a schematic diagram of temperature and density distribution provided by an embodiment of the present disclosure. FIG. 6 shows the temperature and density profiles calculated using integrated physical simulation, where the gray block indicates a position of the “internal transport barrier”, at which the temperature and density are greatly increased. A pressure density deep in a core is significantly increased, leading to a significant increase in plasma fusion power and core bootstrap current. A completely non-inductive operating plasma can be achieved in this way by obtaining a high core bootstrap current in conjunction with a small amount of external current drive. In addition, the formation of the internal transport barrier in the density profile also results in a high density in the core of the plasma.

Radio-frequency local heating or current driving is used to achieve high bootstrap current share tokamak plasma operation. Local radio-frequency current driving is used to actively optimize local magnetic shear and reduce turbulent transport, thus promoting higher confinement and reducing a heating power required to increase the plasma specific pressure.

In an embodiment of the disclosure, the method further includes the following steps.

A state after plasma breakdown is simulated with preset parameters, where the preset parameters include an initial plasma current, an initial equilibrium point and an initial configuration.

A magnetic flux change at a preset observation point is monitored and fed back to a feedback control system, where the magnetic flux change includes a polar position and a vertical position.

An early shaped discharge mode of the plasma is controlled by the feedback control system to maintain a configuration equilibrium of the plasma.

The plasma is heated with an auxiliary heating power of 20 MW, where the auxiliary heating power consists of 10 MW of ion cyclotron wave heating and 10 MW of neutral beam heating. 2 MW of low-hybrid wave heating is additionally introduced during a ramp-up phase, so as to achieve a mixed operation mode.

When implementing this embodiment, after completing the optimization scheme of the plasma breakdown and start-up of the superconducting tokamak, a design of a discharge plan for the mixed operation mode is performed through the following process.

The feedback control system, which is configured for monitoring magnetic flux change at the preset observation point followed feeding back to the coil current to maintain the configuration equilibrium including the poloidal and vertical positions, plasma current and configuration of the plasma, is used to completely simulate a discharge process from a moment of plasma static equilibrium of an initial discharge ramping up to a current in a flat-top section and an evolution of the plasma after the flat-top section. A state after plasma breakdown is simulated by a simulated discharge in the mixed operation mode with the initial plasma current of 500 kA and an initial time of 2 s as the initial equilibrium point. A plasma configuration is restricted to a high longitudinal field side to start the evolution from a circular configuration to a divertor configuration. The early shaped discharge mode of the plasma is used to optimize current density distribution and reduce volt-second consumption.

A preset initial equilibrium time is 2 s, while the plasma current is 500 kA, and the circular configuration is present. The plasma current having a fixed current ramp-up rate of 0.25 MA/s reaches a flat-top section of 5.3 MA at 30 s, with an average electron line density reaching 9×10¹⁹/m³. The feedback control system is used to control the early shaped discharge mode of the plasma. Configuration parameters such as major radius, minor radius, elongation ratio and triangular deformation reach stability in about 6 s. After forming, the major radius is 3.65 m, the minor radius is 1.1 m, the elongation ratio is about 1.65, and the triangle deformation is about 0.3.

Regarding the mixed operation mode, 20 MW of the auxiliary heating power consisting of 10 MW of the ion cyclotron wave heating and 10 MW of the neutral beam heating is used for heating, and 2 MW of the low-hybrid wave heating is additionally introduced during the ramp-up phase to optimize the current density distribution.

The simulation results show that alpha particles have a heating power of slightly more than 5 MW in the flat-top section and a fusion gain factor Q of about 1.2. After designing the discharge scheme of the mixed operation mode, in the plasma current of 5.3 MA, the bootstrap current is about 1.0 MA, a neutral beam driving current is about 1.2 MA, a fast wave driving current is about 0.2 MA, and a low-hybrid wave in the ramp-up phase can also generate driving current. In such mode, a total proportion of all non-inductive driving currents is about 45%, which is in excellent agreement with the results of other integrated simulation programs.

In an embodiment of the disclosure, the method further includes the following steps.

A state after plasma breakdown is simulated with preset parameters, where the preset parameters include an initial plasma current, an initial equilibrium point and an initial configuration.

A plasma is heated with 15 MW of ion cyclotron wave heating, 10 MW of low hybrid wave heating and 6 MW of neutral beam heating, so as to achieve a steady-state operation mode.

When implementing this embodiment, after completing the design of the optimization scheme of the plasma breakdown and start-up of the superconducting tokamak, a design of a discharge plan for the steady-state operation mode is performed through the following process.

Regarding the steady-state operation mode, a preset initial plasma current is 500 kA, reaching a flat-top section of 3.2 MA at a ramp-up rate of 0.25 MA/s at 12 s, while an average electron line density reaches 1.1×10²⁰/m³. During a simulation based on a Tokamak simulation code (TSC), 15 MW of the ion cyclotron wave heating, 10 MW of the low hybrid wave heating and 6 MW of neutral beam heating are adopted.

The simulation results show that alpha particles have a heating power of about 7 MW and a fusion gain factor Q of about 1.0.

According to the simulation results based on such discharge scheme, in a plasma current of 3.2 MA, a bootstrap current is about 2.0 MA, a neutral beam driving current is about 0.5 MA, and a low hybrid driving current is about 0.3 MA. In such mode, the bootstrap current accounts for approximately 63%, and a total share of all non-inductive drive currents is close to 90%. It is foreseeable that a completely non-inductive current-driven discharge waveform can be achieved through further optimization.

This application can also provide a waveform diagram of a coil current discharge through TSC simulation to evaluate whether a discharge of a device operation plan meets engineering requirements. From the simulation results of the coil current, it can be judged whether all coils maintain operation within engineering limits. During the ramp-up phase, a central solenoid (CS) coil evolves from a positive current to a negative current, leaving a margin to maintain the evolution of the flat-top section.

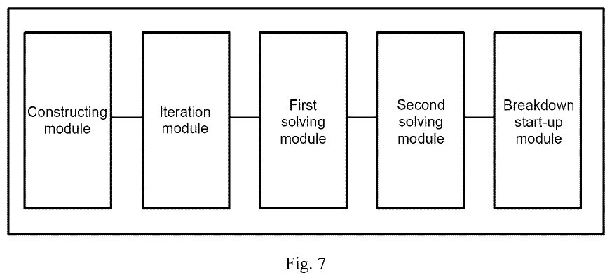

A device for implementing a magnetic confinement reaction is provided in an embodiment. FIG. 7 is a structural diagram of the device, which includes a constructing module, an iteration module, a first solving module, a second solving module and a breakdown start-up module.

The constructing module is configured to construct an initial equilibrium configuration based on zero-dimensional parameters.

The iteration module is configured to determine an equilibrium configuration of a reference equilibrium after iterating with a blanket, a divertor and a magnet.

The first solving module is configured to establish a numerical simulation model of a plasma breakdown phase in a start-up process using a rigid conductor, and optimally solve the numerical simulation model to determine a maximum coil current.

The second solving module is configured to optimize a phase in the start-up process after the plasma breakdown phase into a quadratic programming problem to establish a performance function, and solve the performance function using a preset constraint to determine a to-be-optimized parameter.

The breakdown start-up module is configured to complete the start-up process of a superconducting tokamak according to the equilibrium configuration, the maximum coil current and the to-be-optimized parameter.

The device provided in this embodiment can perform all the steps and functions of the method in any one of the above embodiments. Therefore, specific functions of the device will not be described herein.

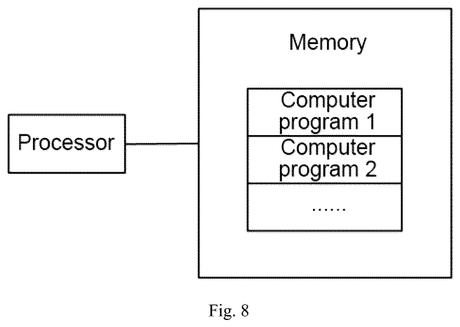

FIG. 8 is a schematic structural diagram of a terminal equipment provided in an embodiment. The terminal equipment includes a processor, a memory and a computer program. The computer program, such as an implementation program of a magnetic confinement reaction device, is stored in the memory, and is configured to be executed by the processor. The processor is configured to execute the computer program to implement the steps of the above method, such as steps (S1)-(S5) shown in FIG. 1. In some embodiments, the processor is configured to execute the computer program to realize the functions of each module of the device in the above embodiments.

In some embodiments, the computer program can be divided into one or more modules. The one or more modules are stored in the memory and executed by the processor to complete the present disclosure. The one or more modules can be a series of computer program instruction segments capable of completing specific functions. The computer program instruction segments are configured to describe an execution process of the computer program in the device for implementing the magnetic confinement reaction. For example, the computer program can be divided into a detection module, an output power control module and a window control module. Specific functions of each module have been described in detail in the method provided in any one of the above embodiments. Therefore, the specific functions of the device will not be described herein.

The device can be a computing device such as a desktop computer, a notebook, a handheld computer, a cloud server, etc. The device can include, but is not limited to, a processor and a memory. Those skilled in the art can understand that the schematic diagram is only an example of the device, and is not intend to limit the device. The device can include more or less components than shown in the drawings, or some components can be combined, or different components. For example, the device can also include input and output devices, network access devices, buses, etc.

The processor can be a central processing unit (CPU), other general-purpose processor, a digital signal processor (DSP), an application specific integrated circuit (ASIC), a field-programmable gate array (FPGA), other programmable logic device, a discrete gate, a transistor logic device or a discrete hardware component. The general-purpose processor can be a microprocessor or any conventional processor. The processor is a control center of the device, and is connected to various portions of an entire device for implementing the magnetic confinement reaction using various interfaces and lines.

The memory can be configured to store the computer program and/or module. The processor implements various functions of the device by running or executing a computer program and/or module stored in the memory and calling data stored in the memory. The memory can mainly include a program storage area and a data storage area. The program storage area can store an operating system and an application program required for at least one function (such as a sound playback function, an image playback function, etc.). The data storage area can store data created based on the use of a mobile phone (such as audio data, phone book, etc.). In addition, the memory can include random access memory, and can also include a non-volatile memory, such as a hard disk drive, an internal memory, a plug-in hard disk, a smart media card (SMC), a secure digital (SD) card, a flash card, at least one disk storage device, a flash memory device, or other volatile solid-state storage device.

When modules integrated by the device for implementing the magnetic confinement reaction are implemented in the form of software functional units and sold or used as independent products, they can be stored in a computer-readable storage medium based on such understanding, the present disclosure can implement all or part of the processes in the above method, which can also be completed by instructing relevant hardware through a computer program. The computer program can be stored in a computer-readable storage medium. When executed by the processor, the computer program can implement the steps of the above method. The computer program includes a computer program code, which can be in a form of a source code, an object code, an executable file or some intermediate form. The computer-readable medium can include any entity or device capable of carrying the computer program code, such as a recording medium a universal serial bus (USB) flash drive, a mobile hard disk, a magnetic disk, an optical disk, a computer memory, a read-only memory, an RAM, an electrical carrier signal, a telecommunications signal and a software distribution medium.

It should be noted that any modifications, changes and replacements made by those skilled in the prior art without departing from the principles of the disclosure shall fall within the scope of the disclosure.

What is claimed is:

1. A method for implementing a magnetic confinement reaction, comprising:
step (1) constructing an initial equilibrium configuration based on zero-dimensional parameters;
step (2) subjecting the initial equilibrium configuration to iteration with a blanket, a divertor and a magnet to determine an equilibrium configuration corresponding to a reference equilibrium;
step (3) establishing a numerical simulation model of a plasma breakdown phase in a start-up process using a rigid conductor, and optimally solving the numerical simulation model to determine a maximum coil current;
step (4) optimizing a phase in the start-up process after the plasma breakdown phase into a quadratic programing problem to establish a performance function, and solving the performance function using a preset constraint to determine a to-be-optimized parameter; and
step (5) completing the start-up process of a superconducting tokamak according to the equilibrium configuration, the maximum coil current and the to-be-optimized parameter.

2. The method of claim 1, wherein the zero-dimensional parameters comprise plasma current, major radius, minor radius, elongation ratio, 95-plane elongation ratio, triangularity, 95-plane triangularity, top triangularity, bottom triangularity, volume, inner leg length of the divertor and outer leg length of the divertor.

3. The method of claim 1, wherein the step (3) is performed through steps of:
establishing the numerical simulation model of the plasma breakdown phase using the rigid conductor;
setting a voltage of a poloidal field coil to change piecewise and linearly, and converting the numerical simulation model into an integrated model;
designing a maximum excitation current and an initial zero-field optimization to convert the integrated model into a given performance function; and
solving the given performance function by linear least-square fitting according to given device parameters to obtain an excitation current of the poloidal field coil as the maximum coil current;
wherein a circuit equation of active coils of the numerical simulation model is expressed as:
$${M}_{cc} \frac{{dI}_{c}}{dt} + {R}_{c} {I}_{c} + {M}_{cv} \frac{{dI}_{v}}{dt} = {V}_{c} ,$$
and a circuit equation of passive conductors of the numerical simulation model is expressed as:
$${M}_{vv} \frac{{dI}_{v}}{dt} + {R}_{v} {I}_{v} + {M}_{cv} \frac{{dI}_{c}}{dt} = 0 ;$$
wherein M_{cc} is a mutual inductance between the active coils, Mᵥᵥ is a mutual inductance between the passive conductors, M_{cv} is a mutual inductance between the active coils and the passive conductors, R_{c} is a resistance of each of the active coils, Rᵥ is a resistance of each of the passive conductors, I_{c} is a current on each of the active coils, Iᵥ is a current on each of the passive conductors, and V_{c} is a voltage across each of the active coils;
the integrated model is expressed as:
$$M \dot{I} + RI = {V}_{0} + {\dot{V}}_{0} t ;$$
wherein M is a mutual inductance matrix, R is a resistance vector, I is a current vector, V₀ is a voltage vector at time t₀, İ is a conductor current change rate, \dot{V}₀ is a voltage change rate at the time t₀, and \dot{V}₀ is expressed as:
$${\dot{V}}_{0} = \frac{{V}_{1} - {V}_{0}}{{t}_{1} - {t}_{0}} ,$$
wherein V₁ is a voltage vector at time t₁;
the given performance function is expressed as:
$$F ( {I}_{i} ) = \vert \begin{matrix}{ψ}_{0} - {{\sum }^{{n}_{c}}}_{i = 1} {M}_{ci} {I}_{i} \\ {B}_{z 1} - {{\sum }^{{n}_{c}}}_{i = 1} {G}_{c 1 i} {I}_{i} \\ {B}_{z 2} - {{\sum }^{{n}_{c}}}_{i = 1} {G}_{c 2 i} {I}_{i} \\ ⋮ \\ {B}_{{zn}_{pt}} - {{\sum }^{{n}_{c}}}_{i = 1} {G}_{{cn}_{pt} i} {I}_{i}\end{matrix} \vert ;$$
wherein n_{c} is the number of loops of the poloidal field coil, ψ₀ is a magnetic flux at a plasma breakdown center, B_{z1}−B_{zn}_{ₚₜ} are magnetic fields in plasma optimization areas, G_{c1i}−G_{cn}_{ₚₜ}ᵢ are Green's functions of the passive conductors versus plasma optimization areas, nₚₜ is the number of the plasma optimization areas, M_{ci} is a mutual inductance coefficient matrix of the passive conductors versus the plasma optimization areas, Iᵢ is a to-be-determined coil current, and F(Iᵢ) is a to-be-optimized performance function;
the given device parameters comprise coordinates of the plasma breakdown center, a size of a vacuum chamber, a maximum number of volt seconds provided by the poloidal field coil, a current limit of the poloidal field coil, a maximum current change rate and a terminal voltage limit of the poloidal field coil.

4. The method of claim 1, wherein the performance function is expressed as:
$$F ( V ) = \sum {( {\overline{Φ}}_{i} - {Φ}_{i}^{tgt} )}^{2} ;$$
wherein V is a coil voltage ratio, Φᵢ^{tgt} is a target value of plasma parameters, comprising loop voltage, vertical field intensity and current ramp-up rate, Φ̅ᵢ is an optimized calculated value of a corresponding plasma parameter, i is a subscript of a to-be-determined plasma parameter, and F(V) is an optimized performance function; and
the preset constraints comprise preset coil parameters and power supply parameters, and the to-be-optimized parameter comprises zero-field distribution, vertical field distribution, loop voltage value and initial rising waveform of a plasma current.

5. The method of claim 1, further comprising:
driving a plasma using a radio-frequency current distributed in a radial direction, and enhancing a local reversed magnetic shear structure in a safety factor profile to optimize a local magnetic shear.

6. The method of claim 1, further comprising:
simulating a state after plasma breakdown with preset parameters, wherein the preset parameters comprise an initial plasma current, an initial equilibrium point and an initial configuration;
monitoring a magnetic flux change at a preset observation point followed by feeding back to a feedback control system, wherein the magnetic flux change comprises a polar position and a vertical position;
controlling, by the feedback control system, an early shaped discharge mode of the plasma to maintain a configuration equilibrium of the plasma; and
heating the plasma with an auxiliary heating power of 20 MW, wherein the auxiliary heating power consists of 10 MW of ion cyclotron wave heating and 10 MW of neutral beam heating, and additionally introducing 2 MW of low-hybrid wave heating during a ramp-up phase, so as to achieve a mixed operation mode.

7. The method of claim 1, further comprising:
simulating a state after plasma breakdown with preset parameters, wherein the preset parameters comprise an initial plasma current, an initial equilibrium point and an initial configuration; and
heating plasma with 15 MW of ion cyclotron wave heating, 10 MW of low hybrid wave heating and 6 MW of neutral beam heating, so as to achieve a steady-state operation mode.

8. A device for implementing a magnetic confinement reaction, comprising:
a constructing module;
an iteration module;
a first solving module;
a second solving module; and
a breakdown start-up module;
wherein the constructing module is configured to construct an initial equilibrium configuration based on zero-dimensional parameters;
the iteration module is configured to determine an equilibrium configuration of a reference equilibrium after iterating with a blanket, a divertor and a magnet;
the first solving module is configured to establish a numerical simulation model of a plasma breakdown phase in a start-up process using a rigid conductor, and optimally solve the numerical simulation model to determine a maximum coil current;
the second solving module is configured to optimize a phase in the start-up process after the plasma breakdown phase into a quadratic programming problem to establish a performance function, and solve the performance function using a preset constraint to determine a to-be-optimized parameter; and
the breakdown start-up module is configured to complete the start-up process of a superconducting tokamak according to the equilibrium configuration, the maximum coil current and the to-be-optimized parameter.

9. A terminal equipment, comprising:
a processor;
a memory; and
a computer program;
wherein the computer program is stored in the memory, and is configured to be executed by the processor; and the processor is configured to execute the computer program to implement the method of claim 1.

10. A computer-readable storage medium, wherein a computer program is stored on the computer-readable storage medium; and the computer program is configured to be executed to control a device equipped with the computer-readable storage medium to implement the method of claim 1.
